(19) United States
(12) Patent Application Publication
(10) Pub. No.: US 2003/0166491 A1
(43) Pub. Date: Sep. 4, 2003

(54) Detergent composition in tablet form

(75) Inventors: John George Chambers, Wirral (GB); John Edley Wilson, Prenton (GB); Douglas Wraige, Chester (GB)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/346,212

(22) Filed: Jan. 17, 2003

(30) Foreign Application Priority Data
Jan. 21, 2002 (GB) 0201300.1

(51) Int. Cl. C11D 17/00

(52) U.S. Cl. 510/445; 510/446; 510/447

(57) ABSTRACT

A compacted laundry detergent tablet which comprises (a) solid particulate detergent base powder comprising surfactant and optionally builder; (b) optionally other particulate detergent ingredients; and (c) a binder material between the detergent base powder particles and/or the optional particulate detergent ingredients wherein the binder comprises (c)(i) from 10 wt % to 90 wt % of a nonionic surfactant having a melting point of from 30 to 70° C.; and (c)(ii) from 10 wt % to 90 wt % of a water-soluble organic material having a melting point of from 30 to 70° C. Preferred nonionic surfactants are the primary and secondary aliphatic alcohol ethoxylates and preferred organic materials are the polyethylene glycols.

### TECHNICAL FIELD

The present invention relates to tabletted detergent compositions which comprise nonionic surfactant as a component of the binder material.

### INTRODUCTION

Detergent tablets are now well known in the art and provide significant advantages to the consumer compared with conventional particulate detergent powders.

It is highly desirable to provide a tablet which is both physically robust and also rapidly dissolves in the wash, however it can be difficult to obtain both properties together. Tablets formed using a low compaction pressure tend to crumble and disintegrate on handling and packing; while more forcefully compacted tablets may be sufficiently cohesive but then fail to disintegrate or disperse to an adequate extent in the wash.

Furthermore it is generally understood that the dissolution behaviour of such tablets is inhibited by the presence of surfactant as it can form gel phases during dissolution. One particular problem is with nonionic surfactants (e.g. in WO 0037604) especially when zeolites are also present.

One way of improving the strength and dissolution properties of surfactant-containing detergent tablets is to coat the detergent particles with a binder prior to compaction.

EP 522 766 (Unilever) discloses many different types of binder and teaches that at least the detergent active particles and builder particles should be coated prior to compaction.

EP 711 828 discloses a process of making compacted laundry detergent tablets by using a binder with a melting point of from 35 to 90° C. which is compacted at a temperature above 28° C. but below the melting point of the binder.

However, one drawback of using dissolution enhancing binders is that they often provide little or no washing function and take up precious formulation space within the tablet. For example a highly preferred binder is polyethylene glycol which is an excellent binder and disintegrant but provides little useful wash function.

Nonionic surfactants have been suggested has potential binders.

GB 2 327 947 (Procter & Gamble) discloses a detergent tablet with a nonionic surfactant as a binder.

However, one problem with using nonionic surfactant as a binder is that the dispersing and dissolution properties of the tablet are found to be poor.

The present inventors have surprisingly found that, contrary to the teachings of previous documents, the strength and dissolution/dispersion properties of a compacted laundry detergent tablet are improved if nonionic surfactant is included as a component of the tablet binder. In addition, since less surfactant may be required in the rest of the composition, the invention provides increased flexibility to formulate ingredients.

### DEFINITION OF INVENTION

In a first aspect, the present invention provides a compacted laundry detergent tablet which comprises:

(a) solid particulate detergent base powder comprising surfactant and optionally builder; and

(b) optionally other particulate detergent ingredients; and

(c) a binder material between the detergent base powder particles and/or the optional particulate detergent ingredients

wherein the binder comprises (c)(i) from 10 wt % to 90 wt % of a nonionic surfactant having a melting point of from 30 to 70° C.; and (c)(ii) from 10 wt % to 90 wt % of a water-soluble organic material having a melting point of from 30 to 70° C.

In a second aspect, the present invention provides a process for preparing a compacted laundry detergent tablet which comprises the steps of:

(i) preparing a detergent base powder;

(ii) mixing the detergent base powder with a binder (c) defined above at a temperature above the melting point of the binder; and

(iii) compacting the resultant material under applied pressure.

### DETAILED DESCRIPTION OF INVENTION

The Binder

Tablets of the present invention comprise a binder which assists the adhesion of the base powder and other detergent ingredients which may be present. The amount of binder may be up to 10 wt % of the total tablet, preferably it is present at from 1 to 6 wt %, more preferably from 2 to 5 wt %.

The binder comprises from 10 to 90 wt % nonionic surfactant. Preferably the binder comprises from 20 to 80 wt %, more preferably from 30 to 70 wt % and desirably from 40 to 60 wt % nonionic surfactant.

It is important that the nonionic surfactant has a soft solid material phase at ambient temperature in order for it to perform well as a binder and/or a disintegrant. In order to achieve this the nonionic surfactant has a melting point of from 30 to 70° C., preferably from 40 to 60° C.

Preferred nonionic surfactants are the ethoxylated alcohols. Preferably the nonionic surfactant comprises a C₈-C₂₀ primary or secondary aliphatic alcohol ethoxylated with an average of from 8 to 50 moles of ethylene oxide per mole of alcohol. More preferably the nonionic surfactant comprises a C₁₂-C₁₈ primary or secondary aliphatic alcohol ethoxylated with an average of from 10 to 30 moles of ethylene oxide per mole of alcohol.

In addition to the nonionic surfactant, the binder contains a water-soluble organic material. The binder comprises from 10 to 90 wt %, preferably from 20 to 80 wt % and more preferably from 30 to 70 wt % of the water-soluble organic material. Preferably the organic material is an organic polymer. Materials of this class are often used as binders in detergent tablets since they have excellent binding and dissolution properties. An especially preferred class of water-soluble organic polymers is comprised by the polyethylene glycols. The preferred molecular weight of the polyethylene glycols is from 800 to 4000. In a highly preferred embodiment the nonionic surfactant and the organic material are intimately blended together.

It is important that the water-soluble organic material has a soft solid material phase at ambient temperature in order for it to perform well as a binder and/or a disintegrant. In order to achieve this the organic material has a melting point of from 30 to 70° C., preferably from 40 to 60° C.

Without wishing to be bound by theory, it is understood that the organic material interferes with the gel-formation of the nonionic surfactant and therefore prevents its negative influence on, and even improves, the dissolution rate.

The binder may also comprise other materials. In one preferred embodiment the binder comprises a sulphate-type anionic surfactant, preferably a primary alcohol sulphate. If present, the sulphate-type anionic surfactant is preferably a particulate solid and is dispersed within the nonionic surfactant.

Base Powder

A detergent base powder is a powder characterised by substantial homogeneity, i.e. the composition of the individual granules is representative of the base powder as a whole. Granular base powders may be made by a high-speed mixer/granulator, and/or other non-spray drying processes such as fluid bed granulation. The compositions of the present invention may comprise a granular base powder. They may also comprise base powders which may be made by spray-drying.

Base powders typically contain ingredients which form the base of many formulations such as surfactant and builder. Compacted tablets according to the present invention preferably comprise from 20 to 90 wt % base powder, more preferably from 30 to 70 wt % base powder.

Detergent Ingredients

Compacted laundry detergent tablets according to the invention contain, amongst other ingredients, conventional detergent ingredients, notably detergent-active materials (surfactants), and preferably also detergency builders.

Compacted laundry detergent tablets in accordance with the invention may suitably comprise from 5 to 60 wt % of detergent-active surfactant, from 10 to 80 wt % of detergency builder, and optionally other detergent ingredients to 100 wt %.

The detergent tablets will contain, as essential ingredients, one or more detergent active compounds (surfactants) which may be chosen from soap and non-soap anionic, cationic, nonionic, amphoteric and zwitterionic detergent active compounds, and mixtures thereof. Many suitable detergent active compounds are available and are fully described in the literature, for example, in “Surface-Active Agents and Detergents”, Volumes I and II, by Schwartz, Perry and Berch.

The preferred detergent active compounds that can be used are soaps and synthetic non-soap anionic and nonionic compounds. Non-soap anionic surfactants are especially preferred.

Non-soap anionic surfactants are well-known to those skilled in the art. Examples include alkylbenzene sulphonates, particularly linear alkylbenzene sulphonates having an alkyl chain length of C₈-C₁₅; primary and secondary alkylsulphates, particularly C₈-C₁₅ primary alkyl sulphates; alkyl ether sulphates; olefin sulphonates; alkyl xylene sulphonates; dialkyl sulphosuccinates; and fatty acid ester sulphonates. Sodium salts are generally preferred. A preferred anionic surfactant is linear alkylbenzene sulphonate.

Nonionic surfactants may optionally be present in addition to the nonionic surfactant in the binder. These include the primary and secondary alcohol ethoxylates, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants include alkylpoly-glycosides, glycerol monoethers, and polyhydroxyamides (glucamide).

Cationic surfactants may optionally be present. These include quaternary ammonium salts of the general formula R₁R₂R₃R₄N⁺ X⁻ wherein the R groups are long or short hydrocarbyl chains, typically alkyl, hydroxyalkyl or ethoxylated alkyl groups, and X is a solubilising anion (for example, compounds in which R₁ is a C₈-C₂₂ alkyl group, preferably a C₈-C₁₀ or C₁₂-C₁₄ alkyl group, R₂ is a methyl group, and R₃ and R₄, which may be the same or different, are methyl or hydroxyethyl groups); and cationic esters (for example, choline esters).

In an especially preferred cationic surfactant of the general formula R₁R₂R₃R₄N⁺ X⁻, R₁ represents a C₈-C₁₀ or C₁₂-C₁₄ alkyl group, R₂ and R₃ represent methyl groups, R₄ presents a hydroxyethyl group, and X⁻ represents a halide or methosulphate ion.

Optionally, amphoteric surfactants, for example, amine oxides, and zwitterionic surfactants, for example, betaines, may also be present.

Preferably, the quantity of anionic surfactant is in the range of from 5 to 50% by weight of the total composition. More preferably, the quantity of anionic surfactant is in the range of from 8 to 35 wt %, most preferably from 10 to 30 wt %.

Nonionic surfactant, if present, in addition to any which may be present in the binder, is preferably used in an amount within the range of from 1 to 20 wt % in addition to that which may be present in the structured emulsion.

The total amount of surfactant present is preferably within the range of from 5 to 60 wt %.

The compositions may suitably contain from 10 to 80 wt %, preferably from 15 to 70 wt %, of detergency builder. Preferably, the quantity of builder is in the range of from 15 to 50 wt %.

The detergent compositions may contain as builder a crystalline aluminosilicate, preferably an alkali metal aluminosilicate, more preferably a sodium aluminosilicate (zeolite).

The zeolite used as a builder may be the commercially available zeolite A (zeolite 4A) now widely used in laundry detergent powders. Alternatively, the zeolite may be maximum aluminium zeolite P (zeolite MAP) as described and claimed in EP 384 070B (Unilever), and commercially available as Doucil (Trade Mark) A24 from Crosfield Chemicals Ltd, UK.

Zeolite MAP is defined as an alkali metal aluminosilicate of zeolite P type having a silicon to aluminium ratio not exceeding 1.33, preferably within the range of from 0.90 to 1.33, preferably within the range of from 0.90 to 1.20.

Especially preferred is zeolite MAP having a silicon to aluminium ratio not exceeding 1.07, more preferably about 1.00. The particle size of the zeolite is not critical. Zeolite A or zeolite MAP of any suitable particle size may be used.

Also preferred according to the present invention are phosphate builders, especially sodium tripolyphosphate. This may be used in combination with sodium orthophosphate, and/or sodium pyrophosphate.

Other inorganic builders that may be present additionally or alternatively include sodium carbonate, layered silicate, amorphous aluminosilicates.

Most preferably, the builder is selected from sodium tripolyphosphate, zeolite, sodium carbonate, and combinations thereof.

Organic builders may optionally be present. These include polycarboxylate polymers such as polyacrylates and acrylic/maleic copolymers; polyaspartates; monomeric polycarboxylates such as citrates, gluconates, oxydisuccinates, glycerol mono-di- and trisuccinates, carboxymethyloxysuccinates, carboxy-methyloxymalonates, dipicolinates, hydroxyethyl iminodiacetates, alkyl- and alkenylmalonates and succinates; and sulphonated fatty acid salts.

Organic builders may be used in minor amounts as supplements to inorganic builders such as phosphates and zeolites. Especially preferred supplementary organic builders are citrates, suitably used in amounts of from 5 to 30 wt %, preferably from 10 to 25 wt %; and acrylic polymers, more especially acrylic/maleic copolymers, suitably used in amounts of from 0.5 to 15 wt %, preferably from 1 to 10 wt %.

Builders, both inorganic and organic, are preferably present in alkali metal salt, especially sodium salt, form.

Detergent compositions according to the invention may also suitably contain a bleach system, although non-bleaching formulations are also within the scope of the invention.

The bleach system is preferably based on peroxy bleach compounds, for example, inorganic persalts or organic peroxyacids, capable of yielding hydrogen peroxide in aqueous solution. Suitable peroxy bleach compounds include organic peroxides such as urea peroxide, and inorganic persalts such as the alkali metal perborates, percarbonates, perphosphates, persilicates and persulphates. Preferred inorganic persalts are sodium perborate monohydrate and tetrahydrate, and sodium percarbonate. The peroxy bleach compound is suitably present in an amount of from 5 to 35 wt %, preferably from 10 to 25 wt %.

The peroxy bleach compound may be used in conjunction with a bleach activator (bleach precursor) to improve bleaching action at low wash temperatures. The bleach precursor is suitably present in an amount of from 1 to 8 wt %, preferably from 2 to 5 wt %.

Preferred bleach precursors are peroxycarboxylic acid precursors, more especially peracetic acid precursors and peroxybenzoic acid precursors; and peroxycarbonic acid precursors. An especially preferred bleach precursor suitable for use in the present invention is N,N,N′,N′-tetracetyl ethylenediamine (TAED).

A bleach stabiliser (heavy metal sequestrant) may also be present. Suitable bleach stabilisers include ethylenediamine tetraacetate (EDTA) and the polyphosphonates such as Dequest (Trade Mark), EDTMP.

The detergent compositions may also contain one or more enzymes. Suitable enzymes include the proteases, amylases, cellulases, oxidases, peroxidases and lipases usable for incorporation in detergent compositions.

Preferred proteolytic enzymes (proteases) are catalytically active protein materials which degrade or alter protein types of stains when present as in fabric stains in a hydrolysis reaction. They may be of any suitable origin, such as vegetable, animal, bacterial or yeast origin.

Proteolytic enzymes or proteases of various qualities and origins and having activity in various pH ranges of from 4-12 are available. Proteases of both high and low isoelectric point are suitable.

Other enzymes that may suitably be present include lipases, amylases, and cellulases including high-activity cellulases such as Carezyme (Trade Mark) ex Novo.

In particulate detergent compositions, detergency enzymes are commonly employed in granular form in amounts of from about 0.1 to about 3.0 wt %. However, any suitable physical form of enzyme may be used in any effective amount.

Antiredeposition agents, for example, cellulose esters and ethers, for example sodium carboxymethyl cellulose, may also be present.

The compositions may also contain soil release polymers, for example sulphonated and unsulphonated PET/POET polymers, both end-capped and non-end-capped, and polyethylene glycol/polyvinyl alcohol graft copolymers such as Sokolan (Trade Mark) HP22.

Especially preferred soil release polymers are the sulphonated non-end-capped polyesters described and claimed in WO 95 32997A (Rhodia Chimie).

The detergent compositions may also include one or more inorganic salts other than builder salts. These may include, for example, sodium bicarbonate, sodium silicate, sodium sulphate, magnesium sulphate, calcium sulphate, calcium chloride and sodium chloride. Preferred inorganic salts are sodium sulphate, sodium chloride, and combinations thereof.

The detergent compositions may also contain other inorganic materials, for example, calcite, silica, amorphous aluminosilicate, or clays.

Other ingredients that may be present include solvents, hydrotropes, fluorescers, dyes, photobleaches, foam boosters or foam controllers (antifoams) as appropriate, fabric conditioning compounds, and perfumes.

Water-Soluble Disintegration-Promoting Particles

A tablet or a region of a tablet may contain water-soluble particles to promote disintegration. It may be preferred that such particles make up from 3%, preferably from 5% or 10% to 50% by weight of the composition of the tablet or region thereof.

Such soluble particles typically contain at least 50% (of their own weight) of one or more materials which is other than soap or organic surfactant and which has a solubility in deionised water of at least 10 g/100 g at 20° C.

More preferably this water-soluble material is selected from either:

compounds with a water-solubility exceeding 50 g/100 g in deionised water at 20° C.; or

sodium tripolyphosphate, containing at least 50% of its own weight of the phase I anhydrous form, and which is partially hydrated so as to contain water of hydration in an amount which is at least 1% by weight of the sodium tripolyphosphate in the particles.

As will be explained further below, these disintegration-promoting particles can also contain other forms of tripolyphosphate or other salts within the balance of their composition.

If the material in such water-soluble disintegration-promoting particles can function as a detergency builder, (as is the case with sodium tripolyphosphate) then of course it contributes to the total quantity of detergency builder in the tablet composition.

The quantity of water-soluble disintegration-promoting particles may be from 10% up to 30 or 40% by weight of the tablet or region thereof. The quantity may possibly be from 12% up to 25 or 30% or more.

A solubility of at least 50 g/100 g of deionised water at 20° C. is an exceptionally high solubility: many materials which are classified as water soluble are less soluble than this. Materials of such high solubility may be used in amounts from 3%, possibly from 5% or 10% up to 30% by weight of the tablet.

Some highly water-soluble materials which may be used are listed below, with their solubilities expressed as grams of solid to form a saturated solution in 100 g of deionised water at 20° C.:—

| Material | Water Solubility (g/100 g) |
|---|---|
| Sodium citrate dihydrate | 72 |
| Potassium carbonate | 112 |
| Urea | >100 |
| Sodium acetate | 119 |
| Sodium acetate trihydrate | 76 |
| Magnesium sulphate 7H₂O | 71 |

By contrast the solubilities of some other common materials at 20° C. are:—

| Material | Water Solubility (g/100 g) |
|---|---|
| Sodium chloride | 36 |
| Sodium sulphate decahydrate | 21.5 |
| Sodium carbonate anhydrous | 8.0 |
| Sodium percarbonate anhydrous | 12 |
| Sodium perborate anhydrous | 3.7 |
| Sodium tripolyphosphate anhydrous | 15 |

Preferably this highly water soluble material is incorporated as particles of the material in a substantially pure form (i.e. each such particle contains over 95% by weight of the material). However, the said particles may contain material of such solubility in a mixture with other material, provided that material of the specified solubility provides at least 50% by weight of these particles.

A preferred material is sodium acetate in a partially or fully hydrated form.

It may be preferred that the highly water-soluble material is a salt which dissolves in water in an ionised form. As such a salt dissolves it leads to a transient local increase in ionic strength which can assist disintegration of the tablet by preventing nonionic surfactant from swelling and inhibiting dissolution of other materials.

Another possibility which is less preferred is that the said particles which promote disintegration are particles which contain sodium tripolyphosphate with more than 50% (by weight of the particles) of the anhydrous phase I form, and which is partially hydrated so as to contain water of hydration in an amount which is at least 1% by weight of the sodium tripolyphosphate.

Sodium tripolyphosphate is very well known as a sequestering builder in detergent compositions. It exists in a hydrated form and two crystalline anhydrous forms. These are the normal crystalline anhydrous form, known as phase II which is the low temperature form, and phase I which is stable at high temperature. The conversion of phase II to phase I proceeds fairly rapidly on heating above the transition temperature, which is about 420° C., but the reverse reaction is slow. Consequently phase I sodium tripolyphosphate is metastable at ambient temperature.

A process for the manufacture of particles containing a high proportion of the phase I form of sodium tripolyphosphate by spray drying below 420° C. is given in U.S. Pat. No. 4,536,377.

These particles should also contain sodium tripolyphosphate which is partially hydrated. The extent of hydration should be at least 1% by weight of the sodium tripolyphosphate in the particles. It may lie in a range from 1 to 4%, or it may be higher. Indeed fully hydrated sodium tripolyphosphate may be used to provide these particles.

The remainder of the tablet composition used to form the tablet or region thereof may include additional sodium tripolyphosphate. This may be in any form, including sodium tripolyphosphate with a high content of the anhydrous phase II form.

Suitable material is commercially available. Suppliers include Rhone-Poulenc, France and Albright & Wilson, UK.

The Process for Making the Compacted Laundry Detergent Tablets

(i) Preparation of the Base Powder

Base powders of low to moderate bulk density may be prepared by spray-drying a slurry, and optionally postdosing (dry-mixing) further ingredients. “Concentrated” or “compact” powders may be prepared by mixing and granulating processes, for example, using a high-speed mixer/granulator, or other non-tower processes.

(ii) Preparation of the Pre-Compaction Powder Formulation

Once the base powder has been prepared it is usually mixed with other ‘post-dosed’ materials such as the water-soluble disintegration-promoting particles and possibly other particulate detergent ingredients.

The binder is then added to the dry powder at a temperature such that it is in liquid form. The liquid and solids are mixed together in any suitable mixing device until the liquid and solids are relatively well mixed. The resultant formulation is allowed to cool and the binder, which is present on the surface of the particles and therefore present between them, solidifies. The resultant particulate formulation is then tabletted to form the compacted laundry detergent tablet.

(iii) Tableting

Tableting entails compaction of a particulate composition under applied pressure. A variety of tableting machinery is known, and can be used. Generally it will function by stamping a quantity of the particulate composition which is confined in a die.

Tableting may be carried out at ambient temperature or at a temperature above ambient which may allow adequate strength to be achieved with less applied pressure during compaction. In order to carry out the tableting at a temperature which is above ambient, the particulate composition is preferably supplied to the tableting machinery at an elevated temperature. This will of course supply heat to the tableting machinery, but the machinery may be heated in some other way also. However, it is preferred that the tableting step is carried out at a temperature below the melting point of the binder.

If any heat is supplied, it is envisaged that this will be supplied conventionally, such as by passing the particulate composition through an oven, rather than by any application of microwave energy.

The size of a tablet will suitably range from 10 to 160 g, preferably from 15 to 60 g, depending on the conditions of intended use, and whether it represents a dose for an average load in a fabric washing or dishwashing machine or a fractional part of such a dose. The tablets may be of any shape. However, for ease of packaging they are preferably blocks of substantially uniform cross-section, such as cylinders or cuboids. The overall density of a tablet for fabric washing preferably lies in a range from 1040 or 1050 gm/litre preferably at least 1100 gm/litre up to 1400 gm/litre. The tablet density may well lie in a range up to no more than 1350 or even 1250 gm/litre. The overall density of a tablet of some other cleaning composition, such as a tablet for machine dishwashing or as a bleaching additive, may range up to 1700 gm/litre and will often lie in a range from 1300 to 1550 gm/litre.

DFS Test Method

As a measure of the resistance of a tablet to fracture, the diametral fracture stress (DFS) is calculated from the following equation:

$$DFS ( Pa ) = \frac{2 P}{π Dt}$$

Where P is the applied pressure to cause fracture (N), D is the tablet diameter (m) and t is the tablet thickness (m).

The tablet is placed on its edge and compressed between two parallel platens until it fractures. From the force required to cause fracture, P, the DFS is calculated from the above equation.

T90 Test Method

A tablet is placed in a domestic cooking sieve which is in turn just submerged into a plastic bucket containing 9 litres of water at 20° C. The shaft of the sieve is attached to a stirrer motor and is rotated at 200 rpm. The conductivity of the water is measured continuously until the conductivity stops increasing. The T90 is the time taken for the conductivity to reach 90% of the final value.

### EXAMPLES

### Examples 1 to 6 and Comparative Examples A and B

A detergent base powder was manufactured by spray drying a slurry of the following formulation.

| Ingredient | Wt % |
|---|---|
| Sodium LAS | 20.8 |
| Nonionic surfactant C₁₆ 7EO | 5.94 |
| Nonionic surfactant C₁₆ 3EO | 3.18 |
| Sodium soap | 1.58 |
| Zeolite MAP | 46.43 |
| Sodium acetate | 5.94 |
| Sodium carbonate | 6.89 |
| Sodium carboxymethyl cellulose | 0.93 |
| Moisture + salts | 8.35 |
| Total | 100.0 |

The resultant base powder was dry-mixed with post-dosed ingredients to produce the following final formulation.

| Ingredient | Wt % |
|---|---|
| Base powder | 50.0 |
| Sodium acetate | 30.0 |
| Sodium carbonate | 10.0 |
| Sodium percarbonate | 10.0 |
| Total | 100.0 |

The binder components used were a nonionic surfactant C₁₆ alcohol ethoxylate with 20 moles of ethoxylate per mole of alkyl group (C₁₆ 20EO), a polyethylene glycol with an average molecular weight of about 1500 (PEG1500), a polyethylene glycol with an average molecular weight of about 1000 ex (PEG1000), and a primary alcohol sulphate surfactant in solid form (PAS). Binder blends were prepared as shown in Table 1.

TABLE 1

| | | |
|---|---|---|
| Binder | Melting | Binder (wt %) |

| ingredient | point (° C.) | 1 | 2 | 3 | 4 |
|---|---|---|---|---|---|
| C₁₆ 20EO | 48 | 33 | 50 | 75 | 100 |
| PEG1500 | 44 | 50 | — | 25 | — |
| PEG1000 | 39 | — | 50 | — | — |
| PAS | >60 | 17 | — | — | — |

Binders were made by mixing the components together in solid form and slowly heating them until they formed a homogenous liquid blend. Whilst in liquid form, the binder was then mixed with the final formulation in order to coat the powder particles with the binder. The binder was added at either 2% or 5% of the weight of the base powder. The resultant powder was then allowed to cool, thereby allowing the binder to solidify. 40 g of the resultant powder was formed into cylindrical detergent tablets of diameter 44 mm by compacting them under a force of 4 kN.

For each binder formulation, two tablets were made. The strength of the tablets was assessed by measuring the diametral fracture strength (DFS). The dissolution rate was assessed by measuring the 90% dissolution time (T90).

The results of the strength and dissolution tests for each of the different binders at different levels of binder are given in Table 2. As discussed above it is desirable to have tablets which are both strong (a high DFS) and yet dissolve rapidly (a low T90). For a given value of DFS tablets with a low T90 are superior. Likewise, for a given T90, tablets with a high DFS are superior. The ability of tablets to satisfy these two requirements having different values of DFS and T90 may be achieved by using the strength/dissolution quotient DFS/T90. A tablet with a high value of the strength/dissolution quotient has superior strength/dissolution properties than a tablet with a low strength/dissolution quotient.

It may be clearly seen that the presence of nonionic surfactant actually improves the tablets strength/dissolution properties. Although the tablets have very good performance over a wide range of surfactant level there appears to be an optimum where around 50% of the binder is nonionic surfactant.

TABLE 2

| | Example | | | | | | | |
|---|---|---|---|---|---|---|---|---|
| | 1 | 2 | 3 | 4 | 5 | 6 | A | B |
| Binder | 1 | | 2 | | 3 | | 4 | |
| Binder | 2% | 5% | 2% | 5% | 2% | 5% | 2% | 5% |
| level | | | | | | | | |
| % Nonionic | 33% | | 50% | | 75% | | 100% | |
| in binder | | | | | | | | |
| DFS | 35 | 45 | 30 | 55 | 30 | 45 | 25 | 43 |
| T90 | 230 | 200 | 130 | 200 | 190 | 210 | 240 | 480 |
| DFS/T90 | 0.152 | 0.225 | 0.231 | 0.275 | 0.158 | 0.214 | 0.104 | 0.090 |

| | | | | |
|---|---|---|---|---|
| Average | 0.189 | 0.253 | 0.186 | 0.097 |

### Examples 7 to 9

The procedure as described above was repeated but with a detergent base powder made by drying an aqueous solution of primary alcohol sulphate (PAS) in a scraped-surface flash dryer. The base powder had the following formulation:

| Ingredient | Wt % |
|---|---|
| PAS | 90 |
| Zeolite MAP | 5 |
| Moisture + minors | 5 |
| Total | 100.0 |

The resultant base powder was dry-mixed with post-dosed ingredients to produce the following final formulation.

| Ingredient | Wt % |
|---|---|
| Base powder | 50.0 |
| Sodium acetate | 30.0 |
| Sodium percarbonate | 20.0 |
| Total | 100.0 |

Tablets were made in the same way as for Examples 1 to 6 but under a compaction force of 0.5 kN. The strength and dissolution properties wear measured and the results are shown in table 3.

TABLE 3

| | Example | | |
|---|---|---|---|
| | 7 | 8 | 9 |
| Binder | 1 | 2 | 3 |
| Type | | | |
| Binder | 5% | 5% | 5% |
| level | | | |
| % Nonionic | 33% | 50% | 75% |
| in binder | | | |
| DFS | 17 | 15 | 15 |
| T90 | 470 | 280 | 470 |
| DFS/T90 | 0.0361 | 0.0536 | 0.0319 |

We claim:

1. A compacted laundry detergent tablet which comprises:
(a) solid particulate detergent base powder comprising surfactant and optionally builder;
(b) optionally other particulate detergent ingredients; and
(c) a binder material between the detergent base powder particles and/or the optional particulate detergent ingredients
wherein the binder comprises
(c)(i) from 10 wt % to 90 wt % of a nonionic surfactant having a melting point of from 30 to 70° C.; and
(c)(ii) from 10 wt % to 90 wt % of a water-soluble organic material having a melting point of from 30 to 70° C.

2. A detergent tablet according to claim 1, which comprises up to 10 wt % of the binder material, preferably from 1 to 6 wt % and more preferably from 2 to 5 wt %.

3. A detergent tablet according to claim 1, wherein the binder comprises from 20 to 80 wt % of the nonionic surfactant.

4. A detergent tablet according to claim 3, wherein the binder comprises from 30 to 70 wt % of the nonionic surfactant.

5. A detergent tablet according to claim 4, wherein the binder comprises from 40 to 60 wt % of the nonionic surfactant.

6. A detergent tablet according to claim 1, wherein the nonionic surfactant has a melting point of from 40 to 60° C.

7. A detergent tablet according to claim 1, wherein the nonionic surfactant is an ethoxylated alcohol.

8. A detergent tablet according to claim 7, wherein the nonionic surfactant comprises a C₈-C₂₀ primary or secondary aliphatic alcohol ethoxylated with an average of from 8 to 50 moles of ethylene oxide per mole of alcohol.

9. A detergent tablet according to claim 8, wherein the nonionic surfactant comprises a C₁₂-C₁₈ primary or secondary aliphatic alcohol ethoxylated with an average of from 10 to 30 moles of ethylene oxide per mole of alcohol.

10. A detergent tablet according to claim 1, wherein the binder comprises from 20 to 80 wt % of the organic material.

11. A detergent tablet according to claim 10, wherein the binder comprises from 30 to 70 wt % of the organic material.

12. A detergent tablet according to claim 1, wherein the organic material has a melting point of from 40 to 60° C.

13. A detergent tablet according to claim 1, wherein the organic material is an organic polymer.

14. A detergent tablet according to claim 1, wherein the organic polymer is a polyethylene glycol.

15. A detergent tablet according to claim 14, wherein the polyethylene glycol has a molecular weight of from 800 to 4000.

16. A detergent tablet according to claim 1, wherein the nonionic surfactant and the organic material are intimately blended together.

17. A detergent tablet according to claim 1, wherein the binder further comprises a sulphate-type anionic surfactant.

18. A detergent tablet according to claim 17, wherein the sulphate-type anionic surfactant is a primary alcohol sulphate.

19. A detergent tablet according to claim 17 or claim 18, wherein the sulphate-type surfactant is a particulate solid and is dispersed within the nonionic surfactant.

20. A detergent tablet according to claim 1, which comprises from 5 to 60 wt % surfactant.

21. A detergent tablet according to claim 1, which comprises from 10 to 80 wt % builder.

22. A process for preparing a compacted laundry detergent tablet which comprises the steps of:
(i) preparing a detergent base powder;
(ii) mixing the detergent base powder with a binder material;
(iii) compacting the resultant material under applied pressure
wherein the binder comprises
(a) from 10 wt % to 90 wt % of a nonionic surfactant having a melting point of from 30 to 70° C.; and
(b) from 10 wt % to 90 wt % of a water-soluble organic material having a melting point of from 30 to 70° C.

23. A process according to claim 22, wherein step (iii) is carried out below the melting point of the binder.
